(19) United States
(12) Patent Application Publication
(10) Pub. No.: US 2024/0311691 A1
(43) Pub. Date: Sep. 19, 2024

(54) ERROR DETERMINATION APPARATUS, ERROR DETERMINATION METHOD AND PROGRAM

(71) Applicant: NIPPON TELEGRAPH AND TELEPHONE CORPORATION, Tokyo (JP)

(72) Inventor: Hidetoshi KAWAGUCHI, Tokyo (JP)

(73) Assignee: NIPPON TELEGRAPH AND TELEPHONE CORPORATION, Tokyo (JP)

(21) Appl. No.: 18/566,652

(22) PCT Filed: Jun. 7, 2021
(86) PCT No.: PCT/JP2021/021569

§ 371 Date: Dec. 3, 2023

(51) Int. Cl. G06N 20/00

(52) U.S. Cl. CPC G06N 20/00

(57) ABSTRACT

An error determination device comprising: a classification estimation process observation unit that acquires data in an estimation process from a classification estimation unit that estimates classification of data to be classified, and generates an estimation process feature vector on a basis of the data; a probability estimation unit that generates an estimated probability vector including probabilities each of which is a probability that the data to be classified belongs to one of classes on a basis of the estimation process feature vector; and an error determination unit that determines whether a classification result by the classification estimation unit is correct or incorrect on a basis of the estimated probability vector, and outputs the classification result, a determination result as to whether the classification result is correct or incorrect, and the estimated probability vector.

### TECHNICAL FIELD

The present invention relates to a technique for classifying information. As an example of a field to which the present technique is applied, there is a technique in which a security operator who handles a security system against cyberattacks, such as an intrusion prevention system (IPS) or anti-virus software, automatically classifies threat information by a machine learning technology or the like.

### BACKGROUND ART

A security operator who handles a security system against cyberattacks collects information on cyberattack activities, such as information on attackers, behavior and methods of the attackers, and vulnerability, as threat information. Since the threat information needs to be generated every day, the security operator needs to continuously and sequentially classify the threat information.

As conventional techniques for performing classification, for example, there are conventional techniques disclosed in Patent Literatures 1 and 2. These conventional techniques propose a technique of automatically determining whether data classification is correct or incorrect. In this technique, the work of classifying data considered to be incorrectly classified is left to a human, so that it is possible to achieve semiautomated data classification work.

### CITATION LIST

### Patent Literature

Patent Literature 1: JP 2020-024513 A
Patent Literature 2: JP 2020-160642 A

### SUMMARY OF INVENTION

### Technical Problem

In the conventional techniques, it is possible to perform data classification and determine whether the data classification is correct or incorrect with high accuracy, but there is a problem that it is not possible to output probabilities each of which is a probability that the classified data belongs to one of classes.

The present invention has been made in view of the above points, and an object of the present invention is to provide a technique capable of outputting probabilities each of which is a probability that certain data belongs to one of classes, in addition to determination as to whether classification of the data is correct or incorrect.

### Solution to Problem

According to the disclosed technique, there is provided an error determination device including:
a classification estimation process observation unit that acquires data in an estimation process from a classification estimation unit that estimates classification of data to be classified, and generates an estimation process feature vector on the basis of the data;
a probability estimation unit that generates an estimated probability vector including probabilities each of which is a probability that the data to be classified belongs to one of classes on the basis of the estimation process feature vector; and
an error determination unit that determines whether a classification result by the classification estimation unit is correct or incorrect on the basis of the estimated probability vector, and outputs the classification result, a determination result as to whether the classification result is correct or incorrect, and the estimated probability vector.

### Advantageous Effects of Invention

According to the disclosed technique, it is possible to output probabilities each of which is a probability that certain data belongs to one of classes, in addition to determination as to whether classification of the data is correct or incorrect.

### BRIEF DESCRIPTION OF DRAWINGS

FIG. 1 is a diagram for describing an overview of an embodiment of the present invention.

FIG. 2 is a diagram for describing an overview of the embodiment of the present invention.

FIG. 3 is a configuration diagram of a classification device 100 according to the embodiment of the present invention.

FIG. 4 is a flowchart for describing a generation method of a classification probability correction vector calculation unit.

FIG. 5 is a diagram illustrating a hardware configuration example of a device.

### DESCRIPTION OF EMBODIMENTS

Hereinafter, an embodiment of the present invention (present embodiment) will be described with reference to the drawings. The embodiment to be described below is merely an example, and an embodiment to which the present invention is applied is not limited to the following embodiment.

### Overview of Embodiment

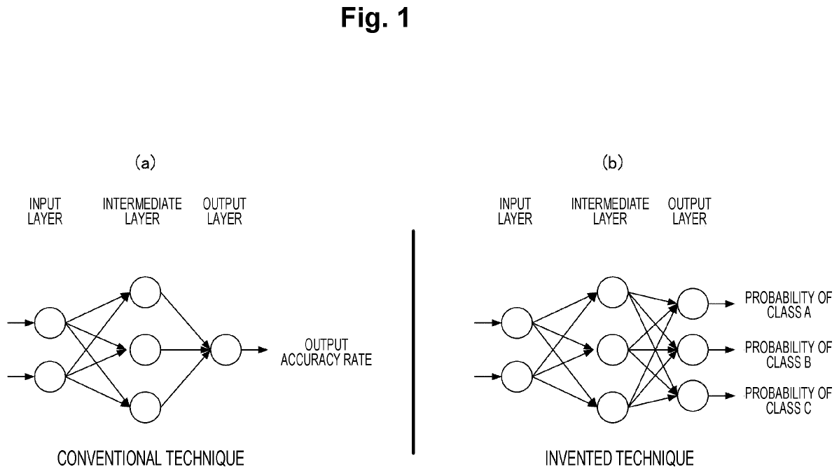

An overview of the present embodiment will be described with reference to FIG. 1. In FIG. 1 (a), an image of a conventional technique is illustrated, and only one accuracy rate is output from a function (neural network) for calculating a certainty factor of classification.

On the other hand, in the technique according to the present embodiment illustrated in FIG. 1 (b), a function for calculating a certainty factor of classification outputs all probabilities each of which is a probability that data belongs to one of classes.

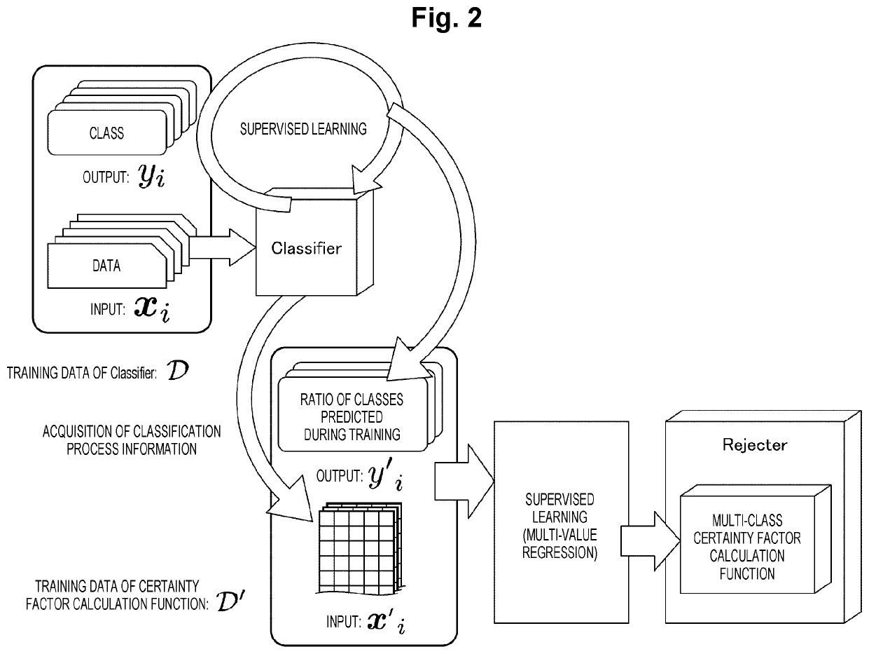

FIG. 2 illustrates an overview of processing contents of a classification device according to the present embodiment. A classifier (corresponding to a classification estimation unit 110 to be described later) performs learning using input data and a class as a correct answer. At the time of learning, the classification estimation unit 110 predicts the class of data many times. A ratio of the predicted classes is used as training data of a multi-class certainty factor calculation function (corresponding to a classification probability correction vector calculation unit 122 to be described later) in a rejecter.

For example, in a case where certain data is predicted to belong to the class A 70 times, is predicted to belong to the class B 20 times, and is predicted to belong to the class C 10 times during supervised learning of the classifier, a ratio [0.7, 0.2, 0.1] serves as a label.

Here, learning of the multi-class certainty factor calculation function is performed by use of the ratio of the predicted classes (the above label) as correct answer data. As a result, it is possible to obtain the multi-class certainty factor calculation function (classification probability correction vector calculation unit 122) capable of predicting probabilities each of which is a probability that certain data belongs to one of the classes with high accuracy.

Hereinafter, the configuration and operation of the classification device according to the present embodiment will be described in detail.

### (Device Configuration Example)

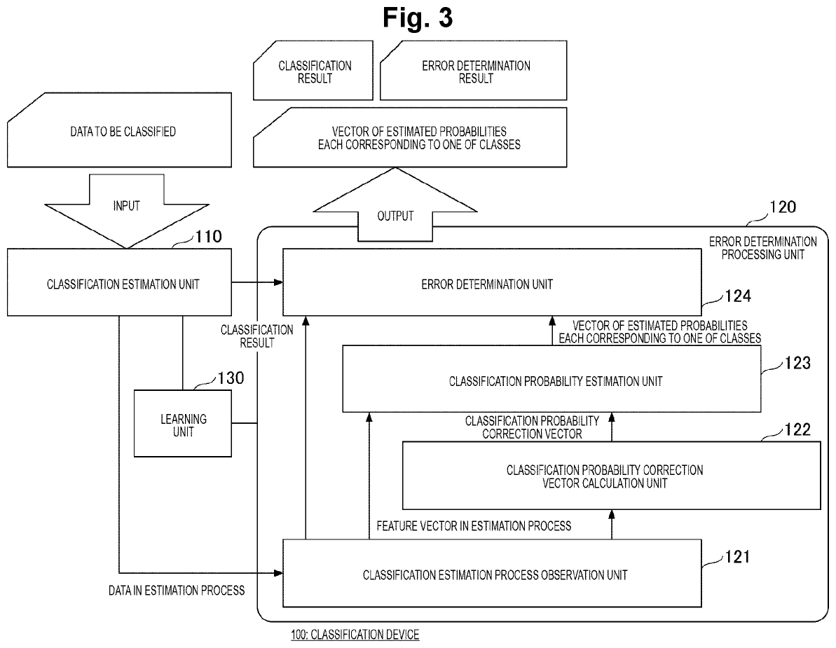

FIG. 3 illustrates a functional configuration diagram of a classification device 100 according to the embodiment of the present invention. As illustrated in FIG. 1, the classification device 100 includes the classification estimation unit 110 and an error determination processing unit 120. The error determination processing unit 120 includes a classification estimation process observation unit 121, the classification probability correction vector calculation unit 122, a classification probability estimation unit 123, and an error determination unit 124.

In addition, the classification device 100 may include a learning unit 130. The learning unit 130 executes a learning operation such as parameter adjustment in supervised learning of the classification estimation unit 110, the classification probability correction vector calculation unit 122, and the like. Note that the learning unit 130 may not be provided in a learned state. In addition, a device including the learning unit 130 as illustrated in FIG. 3 may be referred to as a learning device.

Note that the classification estimation unit 110 and the error determination processing unit 120 may be configured with separate devices and connected via a network, and in this case, the error determination processing unit 120 may be referred to as an error determination device. In addition, a device including the classification estimation unit 110 and the error determination processing unit 120 may be referred to as an error determination device. An overview of the operation of each unit at the time of inference of the classification device 100 is as follows.

### Operation Overview

First, data to be classified is input to the classification estimation unit 110. The data to be classified is data for which some classification is desired to be performed by use of the present system, and corresponds to, for example, threat information.

The classification estimation unit 110 estimates classification of the data to be classified. The method and model for estimation assume artificial intelligence-related technologies such as an SVM and a neural network, but are not limited thereto.

The classification estimation process observation unit 121 observes a calculation process when the classification estimation unit 110 estimates the data to be classified, converts the calculation process into a feature vector (feature vector in the estimation process), and outputs the feature vector.

The classification probability correction vector calculation unit 122 receives the feature vector in the estimation process from the classification estimation process observation unit 121 and calculates a vector for correcting classification probabilities. The classification probability correction vector calculation unit 122 is generated by machine learning. A generation method of the classification probability correction vector calculation unit 122 will be described later.

The classification probability correction vector output from the classification probability correction vector calculation unit 122 is a numerical vector used to correct classification probabilities, and is a real value vector having a class number of dimensions. Note that the classification probability correction vector output from the classification probability correction vector calculation unit 122 may be used as a vector of probabilities each of which is a probability that the data to be classified belongs to one of classes (vector of estimated probabilities each corresponding to one of the classes).

The classification probability estimation unit 123 receives the feature vector in the estimation process from the classification estimation process observation unit 121, receives the classification probability correction vector from the classification probability correction vector calculation unit 122, and calculates probabilities each of which is a probability that the data to be classified belongs to one of the classes. There are a plurality of implementation methods, and details thereof will be described later. The feature vector in the estimation process, a part of the feature vector in the estimation process, or the classification probability correction vector may be output as it is. That is, the classification probability estimation unit 123 may be omitted and the classification probability correction vector calculation unit 122 may be used as the classification probability estimation unit 123.

The classification probability correction vector calculation unit 122 and the classification probability estimation unit 123 may be collectively referred to as a “probability estimation unit”. A functional unit including the classification probability correction vector calculation unit 122 and the classification probability estimation unit 123 may be referred to as a “probability estimation unit”.

The error determination unit 124 receives the classification result, the feature vector in the estimation process, and the estimated probabilities each corresponding to one of the classifications from the classification estimation unit 110, the classification estimation process observation unit 121, and the classification probability estimation unit 123, respectively, and determines whether the classification estimated by the classification estimation unit 110 is “correct” or “erroneous” on the basis of the received information. Furthermore, the error determination unit 124 outputs the error determination result, the classification result, and the vector of estimated probabilities each corresponding to one of the classes as results of the entire system.

The classification result is a result of classification of the data to be classified, and indicates one or more “classes” determined from a predetermined class (classification) list.

The vector of estimated probabilities each corresponding to one of the classes is a probability value of each class output by the classification probability estimation unit 123. For example, in a case where it is assumed that certain data is classified into classes A, B, and C, the probability that the data is classified into A is o %, the probability that the data is classified into B is □%, and the probability that the data is classified into C is Δ%. The error determination result is a result of determination as to whether the classification is erroneous.

Hereinafter, the processing operation of each unit in the error determination processing unit 120 will be described in detail.

### (Classification Estimation Process Observation Unit 121)

First, the classification estimation process observation unit 121 will be described. The classification estimation process observation unit 121 observes the calculation process (data in the estimation process) when the classification estimation unit 110 estimates the data to be classified to configure and output the feature vector (feature vector in the estimation process).

The configured feature vector basically differs depending on a model in the classification estimation unit 110. Here, the following (1), (2), and (3) will be described as examples of representative feature vectors.

(1) Feature Vector that can be Commonly Configured by any Classification Estimation Module

Examples of a feature vector that can be commonly configured by any classification estimation module include the following (1-1) and (1-2).

(1-1) Feature Vector Obtained by Converting Data to be Classified into Numerical Vector

In a case where the classification estimation unit 110 is constructed with a machine learning model, the data to be classified is internally converted into a feature vector that is a vector of numerical values. The vector of numerical values is observed and used as a feature vector in the estimation process.

### (1-2) Vector of Estimated Probabilities Each Corresponding to One of Classes

In a case where the classification estimation unit 110 is constructed with a machine learning model that performs multi-class classification, scoring of classification is performed for each class. The scoring is observed and converted into probability values, and the probability values are arranged to obtain the vector of estimated probabilities each corresponding to one of the classes, which is used as a feature vector in the estimation process.

Specifically, the classification estimation process observation unit 121 converts scores (real values) each corresponding to one of the classes obtained by observing the classification estimation unit 110 into a vector of probabilities by using the softmax function. That is, in a case of classification into n classes, assuming that the scores of the classes are a₁, . . . , and aₙ, a probability pₖ of a class k can be calculated as follows.

$${p}_{k} = \frac{{e}^{{a}_{k}}}{{\sum }_{i = 1}^{n} {e}^{{a}_{i}}} \qquad [ Math . 1 ]$$

### (2) Logit Vector

In a case where the classification estimation unit 110 performs classification into classes using a neural network, the classification estimation unit 110 basically estimates the vector of probabilities each corresponding to one of the classifications (classes) from the scores of the classes. The procedure is the same as the procedure of the “vector of estimated probabilities each corresponding to one of the classes” described above, in which the softmax function is applied to a₁, . . . , and aₙ as scores of the classes. The classification estimation process observation unit 121 observes a₁, . . . , and aₙ from the classification estimation unit 110 and uses a₁, . . . , and aₙ as a feature vector in the estimation process.

In addition, prediction scores by any classifier may be used as a feature vector in the estimation process. For example, in a case where the classification estimation unit 110 performs classification into classes using a support vector machine (SVM), distances to the boundary surface are observed as prediction scores, which can be used as a feature vector in the estimation process.

### (3) Feature Vector of Ensemble Classifier

In a case where the classification estimation unit 110 is configured with a plurality of machine learning models, any one or more of the “feature vector obtained by converting the data to be classified into a numerical vector”, the “vector of estimated probabilities each corresponding to one of the classes”, and the “logit vector” described above can be acquired by each machine learning model. A vector obtained by connecting the respective vectors of the plurality of machine learning models can be output as a feature vector in the estimation process.

### (Error Determination Unit 124)

Next, the error determination unit 124 will be described. As illustrated in FIG. 3, the error determination unit 124 receives the classification result, the feature vector in the estimation process, and the estimated probabilities each corresponding to one of the classes, and determines whether the classification estimated by the classification estimation unit 110 is “correct” or “erroneous” on the basis of the received information. Note that only one of the feature vector in the estimation process and the estimated probabilities each corresponding to one of the classes may be used.

Furthermore, the error determination unit 124 outputs the error determination result, the classification result, and the estimated probabilities each corresponding to one of the classes as results of the entire system.

An error determination method executed by the error determination unit 124 is not limited to a specific method, but for example, any one of the following methods 1 to 3 can be used. Any two or all of the methods 1 to 3 may be applied in combination. In addition, the following methods 1 to 3 are examples, and a method other than the following methods 1 to 3 may be used.

### Method 1

In the method 1, the error determination unit 124 determines an index called a certainty factor with a threshold value. Specifically, the error determination unit 124 acquires the maximum value of the estimated probabilities each corresponding to one of the classes, and sets the maximum value as a certainty factor. When the certainty factor is equal to or greater than the set threshold value, it is determined that the classification result into the class is “correct”, and when the certainty factor is smaller than the set threshold value, it is determined that the classification result is “erroneous”. In addition, for the calculation of a certainty factor, a user can arbitrarily set, to the error determination unit 124, any calculation using one of the classification result, the feature vector in the estimation process, and the estimated probabilities each corresponding to one of the classes.

For example, the error determination unit 124 may set, as a certainty factor, a difference (m1−m2) between the maximum value (m1) and the second largest value (m2) in the estimated probabilities each corresponding to one of the classes. Similar calculation can be performed by use of any rank of estimated probability, such as the maximum value and the third value, the maximum value and the fourth value, and the like.

### Method 2

In the method 2, the error determination unit 124 determines an index called an uncertainty with a threshold value. Specifically, the error determination unit 124 calculates an average information amount (entropy) of the estimated probabilities each corresponding to one of the classes, and sets the value as an uncertainty. When the uncertainty is equal to or greater than the set threshold value, it is determined that the classification result is “erroneous”, and when the uncertainty is smaller than the threshold value, it is determined that the classification result is “correct”.

In the classification into n classes, assuming that the probabilities each corresponding to one of the classes are p₁, . . . , and pₙ, the average information amount can be calculated as follows.

$$u = - {{\sum }_{i = 1}}^{n} {p}_{i} log {p}_{i} \qquad [ Math . 2 ]$$

In addition, for the calculation of an uncertainty, the user can arbitrarily set, to the error determination unit 124, any calculation using one of the classification result, the feature vector in the estimation process, and the estimated probabilities each corresponding to one of the classes.

### Method 3

As in the conventional techniques disclosed in Patent Literatures 1 and 2, a determination may be performed by an error determination unit created by machine learning. It is also possible to make a determination by use of any conventional technique other than the conventional techniques disclosed in Patent Literatures 1 and 2.

### (Classification Probability Estimation Unit 123)

Next, the classification probability estimation unit 123 will be described in detail. As illustrated in FIG. 3, the classification probability estimation unit 123 receives the feature vector in the estimation process and the classification probability correction vector, and calculates the vector of estimated probabilities each corresponding to one of the classes. An implementation method for the calculation is not limited to a specific method, but for example, the methods 1 to 3 described below can be used. Note that a method that can be implemented depends on what is included in the feature vector in the estimation process.

### Method 1

In a case where the “estimated probabilities each corresponding to one of the classes” are included in the feature vector in the estimation process, the classification probability estimation unit 123 extracts the “estimated probabilities each corresponding to one of the classes” and outputs the “estimated probabilities each corresponding to one of the classes” as a vector of estimated probabilities each corresponding to one of the classes. In this case, the extracted “estimated probabilities each corresponding to one of the classes” may be output as they are, or probabilities corrected with the classification probability correction vector may be output. The correction may be, for example, taking an average of the extracted “estimated probabilities each corresponding to one of the classes” and estimated probabilities each corresponding to one of the classes in the classification probability correction vector, or may be obtaining a vector by performing other processing.

### Method 2

In the method 2, the classification probability estimation unit 123 outputs the classification probability correction vector as a vector of estimated probabilities each corresponding to one of the classes as it is. In this case, the classification probability estimation unit 123 may be omitted and the classification probability correction vector calculation unit 122 may be used as the classification probability estimation unit 123.

### Method 3

In the method 3, in a case where the feature vector in the estimation process includes the “logit vector” indicated in (2) of the classification estimation process observation unit 121 described above, the vector of estimated probabilities each corresponding to one of the classes is calculated by any one of the following methods 3-1 and 3-2.

### Method 3-1

In the classification into n classes, assuming that the logit vector is [a₁, . . . , aₙ]^{T} and the classification probability correction vector is [b₁, . . . , bₙ]^{T}, the probability pₖ of the class k can be calculated as follows.

$${p}_{k} = \frac{{e}^{{a}_{k} {b}_{k}}}{{\sum }_{i = 1}^{n} {e}^{{a}_{i} {b}_{i}}} \qquad [ Math . 3 ]$$

This pₖ is calculated for all classes, and a vector [p₁, . . . , pₙ]^{T} is set as a vector of estimated probabilities each corresponding to one of the classes.

### Method 3-2

In the classification into n classes, it is assumed that the logit vector is [a₁, . . . , aₙ]^{T}, and the classification probability correction vector is [b₁, . . . , bₙ]^{T}. The maximum value bₘₐₓ of elements in the classification probability correction vector is obtained, and the probability pₖ of the class k is calculated as follows.

$${p}_{k} = \frac{{e}^{{a}_{k} {b}_{max}}}{{\sum }_{i = 1}^{n} {e}^{{a}_{i} {b}_{max}}} \qquad [ Math . 4 ]$$

This pₖ is calculated for all classes, and a vector [p₁, . . . , pₙ]^{T} is set as a vector of estimated probabilities each corresponding to one of the classes.

### (Classification Probability Correction Vector Calculation Unit 122)

Next, the classification probability correction vector calculation unit 122 will be described in detail. As illustrated in FIG. 3, the classification probability correction vector calculation unit 122 receives the feature vector in the estimation process, and calculates and outputs the classification probability correction vector. In the classification into n classes, the classification probability correction vector is an n-dimensional real value vector.

The classification probability correction vector calculation unit 122 is constructed with a machine learning model capable of estimating a plurality of real values. The generation method (parameter tuning method) of the classification probability correction vector calculation unit 122 will be described later.

As a machine learning model capable of estimating a plurality of real values, which is used as the classification probability correction vector calculation unit 122, for example, a neural network, logistic regression, support vector regression (SVR), or the like can be used.

In a case where the neural network is used as the classification probability correction vector calculation unit 122, a plurality of real values can be estimated by a single model. However, the logistic regression or the SVR alone cannot estimate a plurality of real values. In such a case, n machine learning models are prepared, and real values each corresponding to one of the classes are inferred.

Note that the listed items such as the neural network, the logistic regression, and the support vector regression are merely examples, and any machine learning model can be used as long as it is possible to obtain a structure that can estimate a plurality of real values using the machine learning model.

### (Generation Method of Classification Probability Correction Vector Calculation Unit 122)

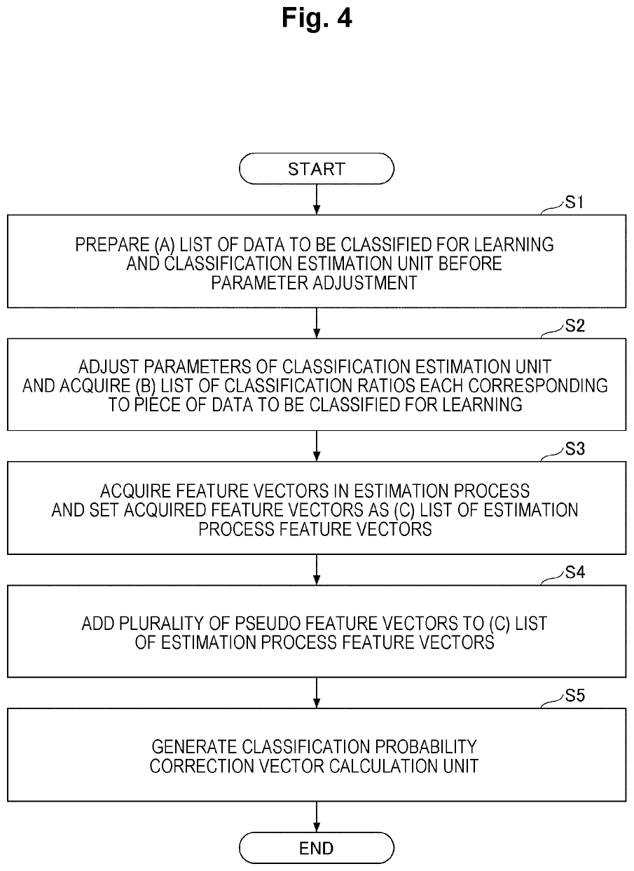

Next, the generation method (parameter adjustment method) of the classification probability correction vector calculation unit 122 will be described along the procedure of the flowchart of FIG. 4. As a premise here, the classification number is n. In the following description, a list of data to be classified for learning is given (A), a list of classification ratios each corresponding to a piece of data to be classified for learning is given (B), and a list of estimation process feature vectors is given (C) in order to facilitate the description. In the following description, it is assumed that each unit is implemented by a neural network, but this is merely an example.

Furthermore, the following processing related to learning is executed by the learning unit 130. The learning unit 130 has a function of holding learning data, a parameter adjustment function (such as a function of executing an error back propagation method), and the like.

### <S1>

In S1 (step 1), (A) the list of data to be classified for learning and the classification estimation unit 110 before parameter adjustment are prepared and held in the learning unit 130.

### <S2>

Parameters of the classification estimation unit 110 are adjusted by a general supervised learning method. In this process, the learning unit 130 acquires (B) the list of classification ratios each corresponding to a piece of data to be classified for learning. (B) The list of classification ratios each corresponding to a piece of data to be classified for learning will be described.

In general supervised learning, data is classified many times in the process of learning, as represented by a neural network. Through the repetition, ratios in classification each corresponding to a piece of data to be classified for learning are listed and the list is set as (B) the list of classification ratios each corresponding to a piece of data to be classified for learning.

For example, in a case where classification into three classes is performed, it is assumed that the neural network classifies a first piece of data and second piece of data 100 times in the learning process. In the process, it is assumed that the first piece of data is classified into a first class 50 times, is classified into a second class 30 times, and is classified into a third class 20 times. In addition, it is assumed that the second piece of data is classified into the first class 10 times, is classified into the second class 70 times, and is classified into the third class 20 times. In this case, (B) the list of classification ratios each corresponding to a piece of data to be classified for learning is [[0.5, 0.3, 0.2]^{T}, [0.1, 0.7, 0.2]^{T}].

### <S3>

In S3, each element of (A) the list of data to be classified for learning is input to the classification estimation unit 110 whose parameters are adjusted in S2, feature vectors in the estimation process are acquired by the classification estimation process observation unit 121, and the acquired feature vectors are set as (C) the list of estimation process feature vectors.

### <S4>

In S4, a plurality of pseudo feature vectors generated by a random number or the like is added to (C) the list of estimation process feature vectors. In addition, n-dimensional vectors in each of which all elements are 1/n are added to (B) the list of classification ratios each corresponding to a piece of data to be classified for learning. The number of n-dimensional vectors added is the same as the number of pseudo feature vectors added to (C).

For example, in a case where classification into three classes is performed, a vector added to (B) is [1/3, 1/3, 1/3]^{T}. The number of vectors added is set by the user of the classification device.

The addition as described above is performed, so that robustness to a random feature vector is obtained, and the accuracy of classification of threat information or the like having an unknown feature is improved. Note that S4 is not essential, and S4 may not be performed.

### <S5>

In S5, the classification probability correction vector calculation unit 122 is generated by supervised learning using (C) the list of estimation process feature vectors processed in S4 as input and (B) the list of classification ratios each corresponding to a piece of data to be classified for learning processed in S4 as output (correct answer). In other words, the parameters of the classification probability correction vector calculation unit 122 are adjusted by supervised learning.

### (Hardware Configuration Example)

The above-described classification device 100 (or the error determination device) can be implemented, for example, by causing a computer to execute a program in which processing contents described in the present embodiment are described. This computer may be a physical computer, or may be a virtual machine on a cloud.

That is, a program corresponding to processing performed by the classification device 100 is executed by use of hardware resources such as a CPU and a memory built in the computer, so that the classification device 100 can be implemented. The above program can be stored and distributed by being recorded in a computer-readable recording medium (portable memory or the like). Furthermore, the above program can also be provided through a network such as the Internet or an electronic mail.

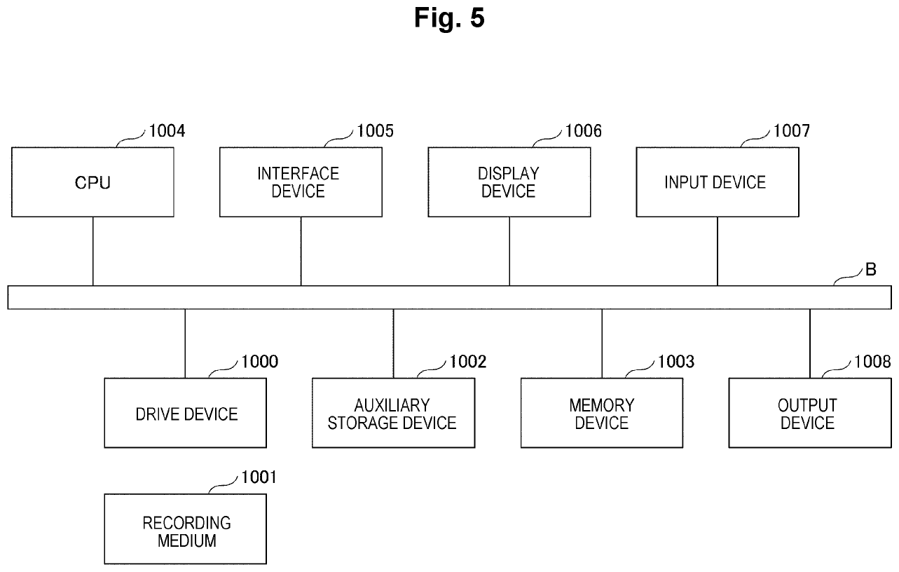

FIG. 5 is a diagram illustrating a hardware configuration example of the computer. The computer in FIG. 5 includes a drive device 1000, an auxiliary storage device 1002, a memory device 1003, a CPU 1004, an interface device 1005, a display device 1006, an input device 1007, an output device 1008, and the like, which are connected to each other by a bus BS.

The program for implementing the processing in the computer is provided by a recording medium 1001 such as a CD-ROM or a memory card. When the recording medium 1001 storing the program is set in the drive device 1000, the program is installed from the recording medium 1001 into the auxiliary storage device 1002 via the drive device 1000. However, the program is not necessarily installed from the recording medium 1001, and may be downloaded from another computer via a network. The auxiliary storage device 1002 stores the installed program and also stores necessary files, data, and the like.

In a case where an instruction to start the program is made, the memory device 1003 reads the program from the auxiliary storage device 1002, and stores the program therein. The CPU 1004 implements a function related to the classification device 100 according to the program stored in the memory device 1003. The interface device 1005 is used as an interface for connection to a network, various measurement devices, a motion intervention device, and the like. The display device 1006 displays a graphical user interface (GUI) or the like according to the program. The input device 1007 includes a keyboard and mouse, buttons, a touch panel, or the like, and is used to input various operation instructions. The output device 1008 outputs a calculation result.

### Effects of Embodiment

With the technique according to the present embodiment, it is possible to output probabilities each of which is a probability that certain data belongs to one of classes, in addition to determination as to whether classification is correct or incorrect. For example, it is assumed that certain data is classified into classes A, B, and C. The classification device 100 can estimate that the probability that the data is classified into A is o %, the probability that the data is classified into B is □%, and the probability that the data is classified into C is Δ%, and present the estimated probabilities to humans.

Furthermore, in the technique according to the present embodiment, a ratio in classification estimated for each piece of learning data is acquired during learning of the classification estimation unit 110, and the acquired ratios are used for learning of the classification probability correction vector calculation unit 122. With such a device, the accuracy of determination as to whether classification is correct or incorrect is improved as compared with the conventional techniques, and the accuracy of estimating a probability for each class estimated in the system is improved.

### Summary of Embodiment

The present specification discloses at least an error determination device, an error determination method, and a program described in the following clauses.

### (Clause 1)

An error determination device including:
a classification estimation process observation unit that acquires data in an estimation process from a classification estimation unit that estimates classification of data to be classified, and generates an estimation process feature vector on the basis of the data;
a probability estimation unit that generates an estimated probability vector including probabilities each of which is a probability that the data to be classified belongs to one of classes on the basis of the estimation process feature vector; and
an error determination unit that determines whether a classification result by the classification estimation unit is correct or incorrect on the basis of the estimated probability vector, and outputs the classification result, a determination result as to whether the classification result is correct or incorrect, and the estimated probability vector.

### (Clause 2)

The error determination device according to clause 1, wherein
the probability estimation unit includes a machine learning model learned by using a ratio in classification of each piece of learning data into the classes as correct answer data, the ratio being acquired during learning of the classification estimation unit.

### (Clause 3)

The error determination device according to clause 1 or 2, wherein
the error determination unit determines whether the classification result is correct or incorrect by comparing a maximum value of the estimated probabilities each corresponding to one of the classes in the estimated probability vector with a threshold value.

### (Clause 4)

The error determination device according to clause 1 or 2, wherein
the error determination unit determines whether the classification result is correct or incorrect by comparing an average information amount of the estimated probabilities each corresponding to one of the classes in the estimated probability vector with a threshold value.

### (Clause 5)

An error determination method executed by a computer, the error determination method including:
a step of acquiring data in an estimation process from a classification estimation unit that estimates classification of data to be classified, and generating an estimation process feature vector on the basis of the data;
a step of generating an estimated probability vector including probabilities each of which is a probability that the data to be classified belongs to one of classes on the basis of the estimation process feature vector; and
a step of determining whether a classification result by the classification estimation unit is correct or incorrect on the basis of the estimated probability vector, and outputting the classification result, a determination result as to whether the classification result is correct or incorrect, and the estimated probability vector.

### (Clause 6)

A program for causing a computer to function as the probability estimation unit, the classification estimation process observation unit, and the error determination unit in the error determination device according to any one of clauses 1 to 4.

Although the present embodiment has been described above, the present invention is not limited to such a specific embodiment, and various modifications and changes can be made within the scope of the gist of the present invention described in the claims.

### REFERENCE SIGNS LIST

100 Classification device
110 Classification estimation unit
120 Error determination processing unit
121 Classification estimation process observation unit
122 Classification probability correction vector calculation unit
123 Classification probability estimation unit
124 Error determination unit
130 Learning unit
1000 Drive device
1001 Recording medium
1002 Auxiliary storage device
1003 Memory device
1004 CPU
1005 Interface device
1006 Display device
1007 Input device
1008 Output device

1. An error determination device comprising a processor configured to execute operations comprising:
acquiring, an estimated classification of data to be classified;
generating an estimation process feature vector on a basis of the data;
generating an estimated probability vector, wherein the estimated probability vector indicates probabilities each of which is a probability that the data to be classified belongs to one of classes on a basis of the estimation process feature vector;
determining whether a classification result of the estimated classification of data is correct or incorrect on a basis of the estimated probability vector;
outputting the classification result, a determination result indicating whether the classification result is correct or incorrect, and the estimated probability vector.

2. The error determination device according to claim 1, wherein
the generating an estimated probability vector uses a machine learning model learned by using a ratio in classification of each piece of learning data into the classes as correct answer data, the ratio being acquired during learning of estimating classification of data.

3. The error determination device according to claim 1, wherein
the determining further comprises determining whether the classification result is correct or incorrect by comparing a maximum value of the estimated probabilities each corresponding to one of the classes in the estimated probability vector with a threshold value.

4. The error determination device according to claim 1, wherein
the determining further comprises determining whether the classification result is correct or incorrect by comparing an average information amount of the estimated probabilities each corresponding to one of the classes in the estimated probability vector with a threshold value.

5. An error determination method executed by a computer, the error determination method comprising:
acquiring an estimated classification of data to be classified;
generating an estimation process feature vector on a basis of the data;
generating an estimated probability vector including probabilities each of which is a probability that the data to be classified belongs to one of classes on a basis of the estimation process feature vector;
determining whether a classification result of the estimated classification estimation of data is correct or incorrect on a basis of the estimated probability vector; and
outputting the classification result, a determination result indicating whether the classification result is correct or incorrect, and the estimated probability vector.

6. A computer-readable non-transitory recording medium storing a computer-executable program instructions that when executed by a processor cause a computer system to execute operations comprising:
acquiring an estimated classification of data to be classified;
generating an estimation process feature vector on a basis of the data;
generating an estimated probability vector including probabilities each of which is a probability that the data to be classified belongs to one of classes on a basis of the estimation process feature vector;
determining whether a classification result of the estimated classification estimation of data is correct or incorrect on a basis of the estimated probability vector; and
outputting the classification result, a determination result indicating whether the classification result is correct or incorrect, and the estimated probability vector.

7. The error determination device according to claim 2, wherein
the determining further comprises determining whether the classification result is correct or incorrect by comparing a maximum value of the estimated probabilities each corresponding to one of the classes in the estimated probability vector with a threshold value.

8. The error determination device according to claim 2, wherein
the determining further comprises determining whether the classification result is correct or incorrect by comparing an average information amount of the estimated probabilities each corresponding to one of the classes in the estimated probability vector with a threshold value.

9. The error determination device according to claim 2, wherein the machine learning model is learned based on supervised learning.

10. The error determination method according to claim 5, wherein
the generating an estimated probability vector uses a machine learning model learned by using a ratio in classification of each piece of learning data into the classes as correct answer data, the ratio being acquired during learning of estimating classification of data.

11. The error determination method according to claim 5, wherein
the determining further comprises determining whether the classification result is correct or incorrect by comparing a maximum value of the estimated probabilities each corresponding to one of the classes in the estimated probability vector with a threshold value.

12. The error determination method according to claim 5, wherein
the determining further comprises determining whether the classification result is correct or incorrect by comparing an average information amount of the estimated probabilities each corresponding to one of the classes in the estimated probability vector with a threshold value.

13. The error determination method according to claim 10, wherein
the determining further comprises determining whether the classification result is correct or incorrect by comparing a maximum value of the estimated probabilities each corresponding to one of the classes in the estimated probability vector with a threshold value.

14. The error determination method according to claim 10, wherein
the determining further comprises determining whether the classification result is correct or incorrect by comparing an average information amount of the estimated probabilities each corresponding to one of the classes in the estimated probability vector with a threshold value.

15. The computer-executable non-transitory recording medium according to claim 6, wherein
the generating an estimated probability vector uses a machine learning model learned by using a ratio in classification of each piece of learning data into the classes as correct answer data, the ratio being acquired during learning of estimating classification of data.

16. The computer-executable non-transitory recording medium according to claim 6, wherein
the determining further comprises determining whether the classification result is correct or incorrect by comparing a maximum value of the estimated probabilities each corresponding to one of the classes in the estimated probability vector with a threshold value.

17. The computer-executable non-transitory recording medium according to claim 6, wherein
the determining further comprises determining whether the classification result is correct or incorrect by comparing an average information amount of the estimated probabilities each corresponding to one of the classes in the estimated probability vector with a threshold value.

18. The computer-executable non-transitory recording medium according to claim 15, wherein
the determining further comprises determining whether the classification result is correct or incorrect by comparing a maximum value of the estimated probabilities each corresponding to one of the classes in the estimated probability vector with a threshold value.

19. The computer-executable non-transitory recording medium according to claim 15, wherein
the determining further comprises determining whether the classification result is correct or incorrect by comparing an average information amount of the estimated probabilities each corresponding to one of the classes in the estimated probability vector with a threshold value.

20. The computer-executable non-transitory recording medium according to claim 15, wherein the machine learning model is learned based on supervised learning.
